(19) United States
(12) Patent Application Publication
(10) Pub. No.: US 2003/0138144 A1
(43) Pub. Date: Jul. 24, 2003

(54) Address matching

(76) Inventor: Stefan Lynggaard, Lund (SE)

Correspondence Address: BIRCH STEWART KOLASCH & BIRCH, PO BOX 747, FALLS CHURCH, VA, 22040-0747, US

(21) Appl. No.: 10/321,622

(22) Filed: Dec. 18, 2002

Related U.S. Application Data
(60) Provisional application No. 60/342,862, filed on Dec. 28, 2001.

(30) Foreign Application Priority Data
Dec. 18, 2001 (SE) 0104318-1

(51) Int. Cl. G06K 9/00

(52) U.S. Cl. 382/181

(57) ABSTRACT

The present invention relates to a method, a system and a computer-readable medium storing computer-executable components for improving a character recognition process. The invention is based on the idea that a sequence of characters is received from a character recognition process and compared to predetermined strings of characters. A measure of matching is generated for each string of characters that is compared to the sequence, indicating which one of the compared strings that best matches the sequence. Based on the measure of matching, a sequence of characters is provided, comprising at least one string selected from the predetermined strings, thereby creating an output sequence of characters. Thus, it is possible to correct an erroneous sequence of characters received from the character recognition process by providing a predetermined string of characters, which string has the highest probability of matching the handwritten text fed to the character recognition process.

### TECHNICAL FIELD OF THE INVENTION

The present invention relates to a method, a system and a computer-readable medium storing computer-executable components for improving a character recognition process.

### BACKGROUND ART

Intelligent character recognition (ICR) and optical character recognition (OCR) are methods employed by computers, or some equivalent computing means, for recognizing handwritten text and converting the text to computer characters.

The text is written into boxes, lines or combs. These boxes, lines or combs aid writing in an ordered way, wherein each letter is written in a separate position, forming a sequence of letters with a well-defined beginning and end.

A character recognition process outputs a list of characters for each position, and the actual matching probability for each character. The probability for each character could be relative to the other choices in this position or absolute, i.e. a percentage value. The sequence of characters that the character recognition process proposes is the sequence that is made up of the characters that has the highest probability in each position.

Character recognition techniques are for example used by banks and post offices to read text written on forms, which text later shall be processed by computers.

A problem with character recognition techniques is that they sometimes misinterpret the handwritten information and produce an erroneous output. This can be very annoying for the receiver of the computer characters, since the receiver never really knows if the produced output is correct or not.

### SUMMARY OF THE INVENTION

An object of the present invention is to provide an improvement of the output of the character recognition process. If the character recognition output is erroneous, the object of the invention is to correct the error.

This object is obtained by a method for improving a character recognition process according to claim 1, a system for improving a character recognition process according to claim 21 and a computer-readable medium storing computer-executable components in accordance with claim 41. Preferred embodiments are defined by the dependent claims.

The invention is based on the idea that a sequence of characters is received from a character recognition process. Segments of characters is identified in the received sequence and each segment is compared to predetermined strings of characters. The comparison is performed on a character by character basis between the characters of the segment and the characters at corresponding positions in the string. A measure of matching is generated for each string of characters that is compared to each segment, which measure indicates which one of the compared strings that is most likely to match the current segment. The measure of matching is calculated based on a matching probability associated with each of the characters in the predetermined strings. Based on the measure of matching, a sequence of characters is provided, wherein the provided sequence of characters comprises at least one segment selected from the predetermined strings. Thereby an output sequence of characters is created. By employing this concept, it is possible to correct an erroneous sequence of characters received from the character recognition process by providing a predetermined string of characters, which string has the highest probability of matching the handwritten text fed to the character recognition process. According to an embodiment of the invention the received sequence of characters consists of an e-mail address and the identification of segments in the sequence is performed by delimiting said segments with the characters “@” and This is an easy way to identify segments in an e-mail address, but the present invention could be applied on other formats as well, such as web addresses, intranet addresses and WAP addresses, as long as it is possible to segment the sequence of characters. It is also possible to choose other formats, it would for example be possible to segment the sequence by dividing the sequence into segments comprising predetermined numbers of characters.

According to further embodiments of the invention, the measure of matching is compared with a predetermined threshold value. If the measure of matching exceeds the threshold value, the matching is considered good enough, and the received sequence of characters is replaced with at least one segment selected from the predetermined strings. By employing a threshold value, a measure of quality is given to the created output sequence of characters.

According to yet further embodiments of the invention, the predetermined strings of characters are arranged in tables, one table for each segment of characters to be compared. A pointer is created, which points from a first string of characters in a first table to at least one second string of characters in a second table. When comparing a segment with the different strings in a table, the measure of matching for a string that has a pointer to it from the string chosen in the previous table is modified by a certain amount, since it is more likely to be associated to the string chosen in the previous table. By using pointers, it is also possible for a user merely to write some of the first characters in, for example, an e-mail address, and the matching address will be provided using the predetermined strings in the tables. Note the term “pointer” in no way should be seen as limiting. The idea of pointers is to create an association, or a link, between given strings in the tables.

According to even further embodiments of the invention, the output sequence of characters is presented to the user on a display of a device, such as a mobile phone, a PDA, a laptop or a digital pen etc. This gives the user an opportunity to accept, or correct, the output sequence of characters by using a character input device in connection with the display device, such as the keypad of a mobile phone, thereby creating a final sequence of characters. Segments of characters will be identified in the final sequence of characters, wherein a segment is added to the corresponding table in case the segment is not already stored in said corresponding table. This enables “learning” of new sequences of characters. The identified segments of characters comprised in a final sequence of characters are arranged with respect to time in the tables. This is done because if two or more predetermined strings of characters have the same measure of matching when each of the strings are compared to a segment of characters, the most recently identified segments of characters are provided as an output sequence. Updating the tables of course implies that the pointers are corrected to point to the associated strings in the other tables.

Further features of, and advantages with, the present invention will become apparent when studying the appended claims and the following description.

### BRIEF DESCRIPTION OF THE DRAWINGS

Embodiments of the present invention will be described in greater detail with reference to the accompanying drawings, in which:

FIG. 1 shows a system for management and communication of information in which the present invention can be advantageously applied;

FIG. 2 shows a character recognition process outputting an erroneous sequence of characters;

FIG. 3 shows tables and preloaded strings of characters according to an embodiment of the invention;

FIG. 4 shows tables, pointers and preloaded strings of characters according to an embodiment of the invention;

FIG. 5 shows a digital pen sending a corrected character recognition output to a mobile phone according to an embodiment of the present invention;

FIG. 6 shows a matching approach, when the concept of improving a character recognition process is extended to handle the loss of one or more letters in a handwritten sequence, according to an embodiment of the invention; and

FIG. 7 shows another matching approach, when the concept of improving a character recognition process is extended to handle the loss of one or more letters in a handwritten sequence, according to an embodiment of the invention.

### DESCRIPTION OF PREFERRED EMBODIMENTS OF THE INVENTION

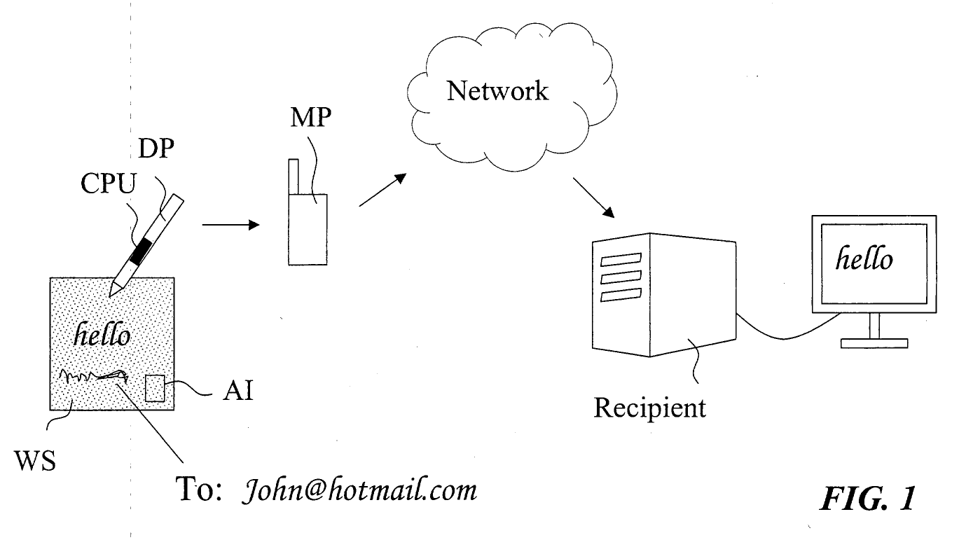

FIG. 1 shows a system for management and communication of information, which system enables electronic recording of information that is being written on a writing surface designed specifically for this system. Such a system is further disclosed in the Applicant's international patent publications W001/48678, W001/48591 and W001/48685, which publications are incorporated herein by reference. The information is written on the surface by means of a digital pen. The pen has a sensor, which detects the information written on the surface. The pen can be used as an input device to a computer, a PDA, a mobile phone or the like. For example, text and sketches written on a notepad, designed specifically for this system, can be transferred from the pen via a network to a computer. The combination of pen and said writing surface allows for global communication, directly from the writing surface via the pen. For example, the information registered by the pen can be transformed to a fax message, an e-mail or an SMS, and then be sent from the pen to a recipient.

When the digital pen DP is operated to mark an activation icon AI on the writing surface WS, the pen DP initiates an operation to forward a message to a designated recipient, for example via short-range radio transmission to a mobile phone MP acting as a modem. Alternatively, the modem could consist of a PDA, a laptop, a computer or the like, and the transmission could be performed via wire. The writing surface WS is arranged with a predetermined address field, where the user writes the address of the recipient. In this case, the address is “john@hotmail.com”.

The pen contains a processor CPU or some equivalent thereof, for example an ASIC or some other programmable hardware, having computing capability in order to perform the steps comprised in the method according to the invention. Consequently, the means included by the system of the invention is implemented by this CPU or its equivalent, which is arranged to perform the function of said means when executing appropriate software code. Moreover, the steps comprised in the method according to the invention could be performed in an external device connected to the pen, such as a mobile phone, a PDA, a computer etc.

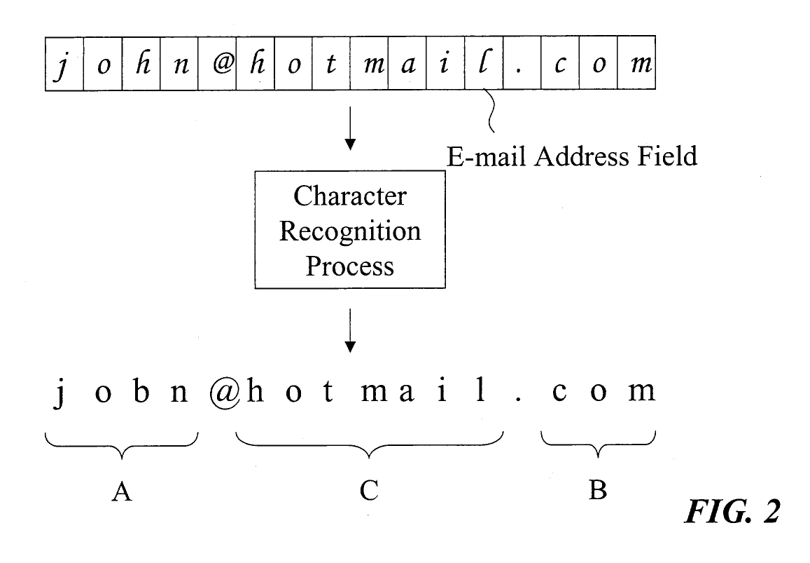

FIG. 2 shows a character recognition process, wherein every letter is handwritten in a predetermined e-mail address field. A character recognition process outputs a list of characters for each position, and an actual matching probability for each character. The sequence of characters that the character recognition process proposes is the sequence that is made up of the characters that has the highest matching probability in each position.

Assuming that the user wrote “john@hotmail.com”, the character recognition process might misinterpret the handwritten sequence of letters and produce the erroneous output “jobn@hotmail.com”, based on the character matching probability. According to an embodiment of the invention, segments A, B and C are identified in the sequence by means of the segment delimiters “@” and “.”. In an e-mail address, the “@” is identified. If there are any subsequent characters following the “@”, the last “.” in the address will be identified, since an address can contain more than one “.”, such as “john@anoto.pen.com”. If the character recognition process fails to produce an “@” or a “.”, the characters that are most probable to be an “@” or a “.” are replaced with an “@” or a “.”, respectively. It is of course understood that, if no subsequent characters follows the “@”, a “.” will not be inserted. Normally character recognition processes are good at detecting these characters, and thus this is seldom necessary.

After the identification of segments, said segments are to be compared with preloaded strings contained in tables, which tables are located in a database or some other equivalent storage means. The database or its equivalent is located in the pen or in some external device in connection to the pen, such as a mobile phone, a PDA, a computer or a server. The preloaded strings consist of preloaded e-mail addresses which, of course, are known to be correct. The object is to find strings in the tables that matches what the user actually wrote, thereby correcting a potentially erroneous output from the character recognition process.

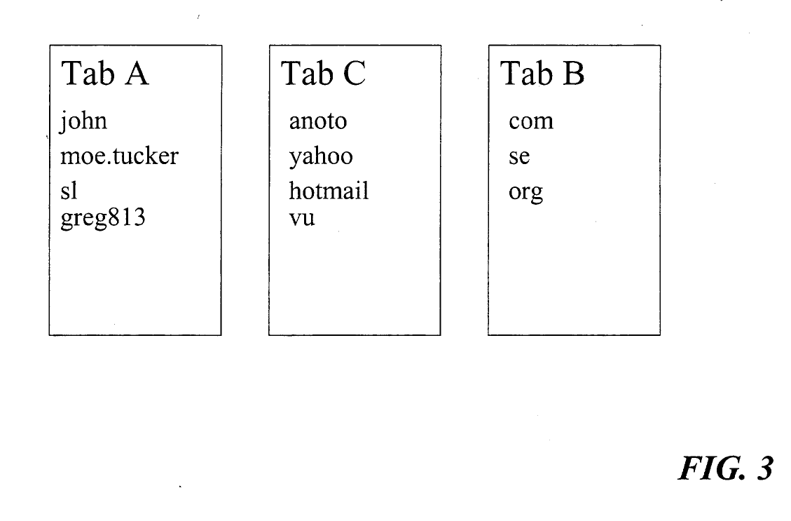

FIG. 3 shows tables and preloaded strings of characters according to the invention. As mentioned hereinabove, when the sequence of characters has been segmented, the object is to find a preloaded string of characters in a table for the current segment (Tab A for segment A, Tab B for segment B and so on) that matches the segment to a certain extent. To this end, the current segment is matched to all, or a selected subset, of the strings in the corresponding table. In this process, each matched string is assigned a measure of matching indicating how probable it is that the chosen string is what the user actually wrote. This is done by employing the matching probability for each individual character, and by combining the matching probabilities. This operation produces the measure of matching, which measure indicates the probability that the current string is what the user really wrote.

For example, segment A output from the character recognition process is identified as “jobn”. This segment is compared to the strings of characters in Tab A. By comparing the segment to the strings in Tab A on a character by character basis, the string “john” matches the segment “jobn” to a measure of 75%, under the condition that each of the characters “j”, “o”, and “n” is given a matching probability of 1 (100%), respectively. In other words, they are considered exact matches. If a character is not considered to be an exact match, it is given, in this specific example, a matching probability of 0. The measure of matching is calculated as (1+1+0+1)/4=75%. The other segments, “hotmail” and “com” are compared to the strings in Tab C and Tab B, respectively. Each of the characters in these two segments is considered to be an exact match, and thus the measure of matching for these two segments is 100%, respectively, since these exact two strings exist in the tables. This specific embodiment is advantageous since a measure of matching can be calculated in a simple manner by giving, for each character in a specific position where there is a match between the segment and the-string, the character the matching probability 1. Each character in a specific position where there is no match is given the matching probability 0.

Assuming that a threshold value of 50% is employed, the segment “jobn” is replaced with “john”, since the measure of matching is considered good enough. If, on the other hand, the threshold value is set to 80%, the segment “jobn” is not replaced, since the measure of matching is not above the threshold value.

A restriction can be introduced, which restriction implies that the strings to be compared with the current segment should have the same number of characters as the number of characters in the current segment. Thereby, the number of matching operations can be reduced. For example, if the current segment contains four characters, it is only compared to strings containing four characters, thus excluding the comparison with strings containing more, or less, than four characters.

A more sophisticated approach can be employed than the one described above, in which approach it is taken into consideration that a character recognition process outputs a list of characters for each position, and a matching probability for each character.

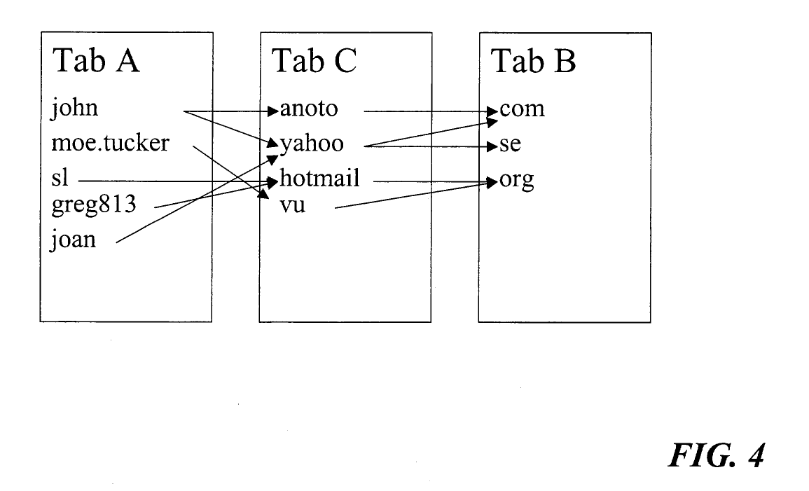

FIG. 4 shows tables, pointers and preloaded strings of characters according to the invention. Assuming that the comparing procedure in connection to FIG. 3 is used, the measure of matching would be the same when comparing “jobn” to “john” and “jobn” to “joan” in Tab A. This would produce rather unsatisfying results in cases where the measure of matching is the same for two or more strings when compared to a given segment. Assuming that the character recognition process proposes that the characters “j”, “o” and “n” are exact matches (matching probability=1) for position 1, 2 and 4, respectively, and that the character recognition process outputs “b”, “h” and “a” for position 3, with a matching probability of 0.5, 0.3 and 0.16, respectively, the measure of matching for “john” would be (1+1+0.3+1)/4=82.5% and the measure of matching for “joan” would be (1+1+0.16+1)/4=79%. The measure of matching is thus higher for “john” than for “joan” and consequently, the segment “jobn” is replaced with “john”, under the condition that a measure of matching of 82.5% is above the predetermined threshold value. In this example, “hotmail” and “com” are not misinterpreted by the character recognition process and they are considered exact matches. When compared to the strings in Tab C and Tab B, respectively, the measure of matching is 100%, since these exact two strings exist in the tables. Since the character recognition process misinterpreted the handwritten text “john@hotmail.com” and produced the output “jobn@hotmail.com”, the erroneous output will be corrected and an output sequence of characters is provided to the user, which sequence matches the handwritten text, i.e. “john@hotmail.com”.

The fact that it is taken into consideration that a character recognition process outputs a list of characters for each position, and a matching probability for each character, is advantageous since the result of the matching is more accurate due to the fact that the matching probability can be given any value in the interval from 0 to 1. Thus, this embodiment can, to a greater extent, present a correct sequence of characters to the user.

It should be noted that depending on the output of the character recognition process, there are many ways to calculate the measure of matching.

As mentioned earlier, the character recognition process could output relative ratings instead of absolute (percentage) ratings. If this is the case, the matching rating for “b” is given as 120, the matching rating for “h” is considered to be 30 and the matching rating for “a” is 10. Since “b” is the most probable match, the matching rating is normalized to 120/120=1, and thus the matching probability is given. The matching probability for “h” is 30/120=0.25, and for “a” it is 10/120=0.083. As a result, “john” is considered more likely to be a match than “joan”. Besides having a different type of rating, this approach is the same as when using percentage ratings.

If two or more strings have the same measure of matching, the most recently used string will be used to replace the segment.

As mentioned earlier, if the measure of matching for a segment exceeds a predetermined threshold value, the matching is considered good enough. By employing a threshold value, a measure of quality is given to the created output sequence of characters. Moreover, the setting of the threshold value is a tradeoff between performance and the probability of having an e-mail address written for the first time changed to something else. For example, if the threshold value is set too low, crazy guesses could be made like changing “sven.johnsson” to “oven.jamesson”, because “sven.johnsson” has never been encountered before and “oven.jamesson” is already in the table.

FIG. 4 also shows the use of pointers according to an embodiment of the invention. The pointers are used for two purposes; (i) to obtain a better result in improving the character recognition process and (ii) to enable the user to write the beginning of an e-mail address and then provide the user with the complete address. For example, “moe.tucker” in Tab A has a pointer to “vu” in Tab C, and “vu” in Tab C has a pointer to “org” in Tab B. When a segment is compared to a string of characters in the table, the measure of matching for the strings that has a pointer to them, from the string chosen in the previous table, is modified by a certain amount. When it is determined that segment A is “moe.tucker” it is more probable that segment C should be “vu” than, say, “yahoo”, since there is no pointer from “moe.tucker” to “yahoo”.

Another benefit of the pointers is that the user will be able to write “moe.tucker@”, and the rest of the e-mail address will be added by using the pointers. If a string has two or more pointers to a string in the next table, the most recently used string will be chosen. It is also possible to just write “mo”, and the rest of the address will be added, by assuming that if no delimiter exist, the characters read is the first segment. Of course, the more characters that are provided by the user, the more likely it is that a correct final sequence of characters is provided to the user. For example, with reference to FIG. 4, if a user writes “jo”, it is impossible to say if the user really meant “john” or “joan”. In this case, the most recently used string will be provided. However, if the user would have written “joa”, the string “joan” would have been provided to the user.

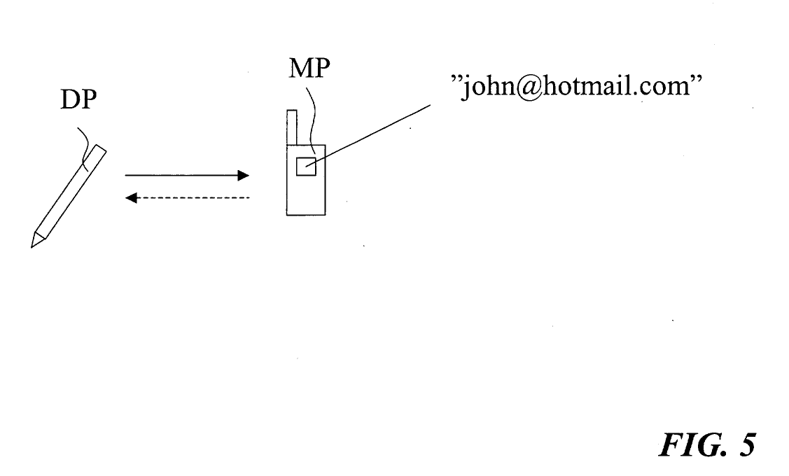

FIG. 5 shows the pen DP presenting the output sequence of characters to a user on the display of a mobile phone MP. The user is thus given an opportunity to accept, or correct, the sequence of characters output on the display, thereby creating a final sequence of characters. The final sequence is returned to the pen DP, which pen DP again segments the final sequence, as described earlier, and updates the tables. As mentioned earlier, it could be returned to some other device in connection to the pen, such as a mobile phone, a PDA or a computer, which device holds the tables. If a segment already exists in the corresponding table, the segment is moved to the first position, thereby indicating the most recently used string. If the segment does not exist in the corresponding table, the segment is added to the first position of the table. The pointers are also corrected to point to the associated strings in the other tables.

The tables can be preloaded with the names of widely used domains and suffixes like “hotmail”, “yahoo”, “com” and “org” to affect the initial performance. An even stronger initial set could be obtained by preloading entries from the user's address book located in, for example, a digital pen, a mobile phone,-a mail client or the like.

It should be noted that those skilled in the art will realize that a number of different embodiments are possible. The tables could for example be sorted with the most recently used segments in the last position of the tables. The important issue here is that they are, or can be, sorted with respect to time. It should also be understood that other types of addresses than e-mail addresses can be improved, such as web addresses, intranet addresses and WAP addresses, wherein the segment delimiters must the be chosen in accordance with the address type of interest. Furthermore, the number of tables could be increased to handle deeper domain addresses like, for example, “bobby.gillespie@primal.creation.com”. Additionally, the concept of improving a character recognition process could be extended to handle the loss of one or more letters in a handwritten sequence. This can be done in many different ways, one way will be described hereinafter.

Assuming that a user wrote “john@yaoo.com” when the intention was to write “john@yahoo.com”, i.e. the user has actually missed the “h” in the third position of “yahoo”. In this specific example, the matching probability that is received from the character recognition process for each character is given as 1. With reference to FIG. 4, “yaoo” is compared to a subset of preloaded strings of characters in Tab C. In this example, the subset comprises strings with the same number of characters as the current segment “yaoo”, that is four characters. In Tab C, no string with four characters can be found. It is then possible to perform the matching by assuming that the user either happened to exclude one character in “yahoo”, resulting in “yaoo”, or simply misspelled “yahoo”. This time, the current segment is assumed to consist of five characters when performing the matching and thus, the current segment is matched against a subset of strings in Tab C, wherein the strings consist of five characters. This might require a number of iterations, as will be described in the following.

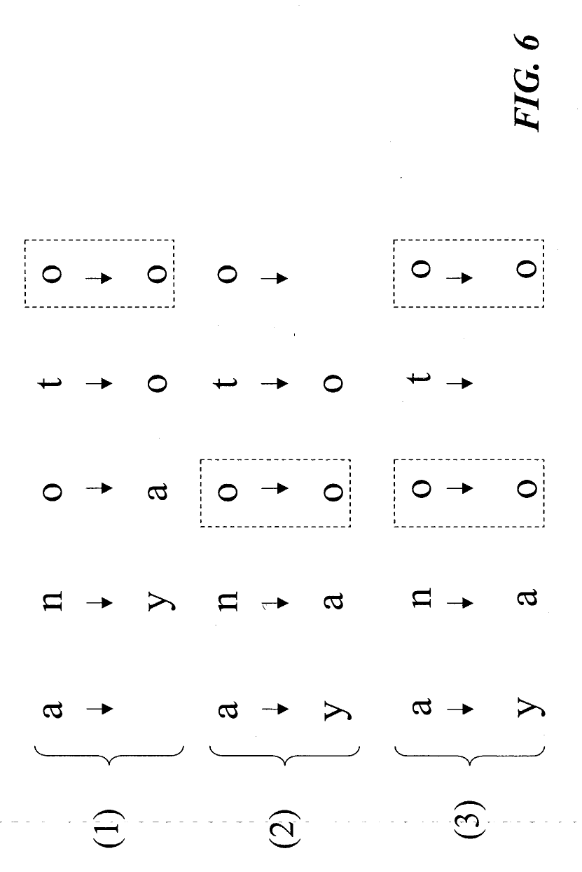

FIG. 6 shows how the matching can be performed, when matching “yaoo” against “anoto”. In FIG. 6, the arrows indicate which characters that are matched against each other and the dashed boxes indicate which characters that match. In (1), the character in the first position is assumed to be excluded, giving a measure of matching of (0+0+0+0+1)/5=20%. In (2), the character in the fifth position is assumed to be excluded, also giving a measure of matching of (0+0+1+0+0)/5=20%. In (3), the character in the fourth position is assumed to be excluded, giving a measure of matching of (0+0+1+0+1)/5=40%. When using this matching approach, this is the best possible measure of matching for this given string. There are two other matching possibilities when using this approach, and that is to assume that the character in the second or the third position is excluded, respectively (not shown in FIG. 6). This will, however, also give measures of matching of 20%. If the threshold value is set to, say, 75%, neither of these measures of matching are considered good enough. Thus, a better measure of matching must be found, if possible.

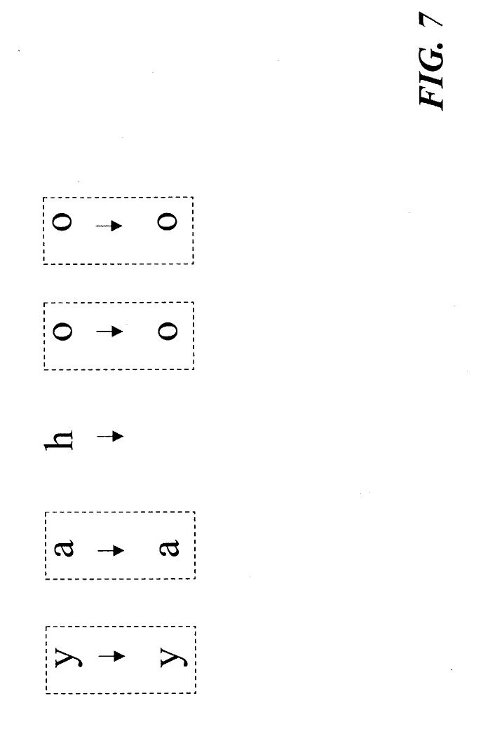

FIG. 7 shows the best matching when matching “yaoo” against “yahoo”, under condition the same matching approach is employed as when matching “yaoo” against “anoto”. The resulting measure of matching will be (1+1+0+1+1)/5=80%. Since this is above the threshold value, the segment “yaoo” is replaced with “yahoo”. In this specific example, the matching performed while assuming that a character is excluded in the third position is actually the only matching that would yield a measure of matching above 75%.

It should be noted that the examples in connection with FIG. 6 and FIG. 7 are exemplifying embodiments only. The strings are not necessarily matched in this order, starting with “anoto” and then continuing with “yahoo”.Neither is it necessary to try all possible positions for one string at a time, i.e. performing five iterations for “anoto” before proceeding to match against “yahoo”, it is possible to switch between different strings for a given segment. Nor is it necessary to assume that the characters are excluded in the position order as given above, that is starting with an excluded character in the first position, continuing with an excluded character in the fifth position and so on. Ideally, in the examples given in connection with FIG. 6 and FIG. 7, the starting position for the matching would be as shown in FIG. 7. In that case, only one matching would have to be performed to achieve a measure of matching above 75%.

As is clearly understood from the above, a tradeoff must be done between the time it takes to perform these iterations and the quality of the output provided to the user. This emphasizes the importance of having a large set of preloaded entries in the tables.

The character recognition process is not necessarily performed in the pen, but can be performed in some other part of the system, for example in a server. Files containing necessary data can then be distributed between concerned parties involved in the character recognition process improvement.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method for improving a character recognition process, comprising the steps of:
receiving a sequence of characters;
identifying at least one segment of characters in the sequence;
comparing said at least one segment with predetermined strings of characters, whereby a measure of matching is generated for each string, wherein the comparison is performed on a character by character basis between characters of the segment and characters at corresponding positions in the string and wherein said measure of matching is calculated based on a matching probability associated with each of the characters in the predetermined strings; and
providing a sequence of characters comprising at least one segment selected from the predetermined strings, based on the measure of matching, thereby creating an output sequence of characters.

2. The method according to claim 1, wherein the measure of matching is calculated by means of combining the number of character by character matches between the segment and the string.

3. The method according to claim 2, further comprising the step of:
receiving, for at least part of the characters in said sequence, at least one alternative character and a corresponding probability value, wherein the measure of matching is further calculated based on the probability value of any alternative character that matches a character at a corresponding position in the string.

4. The method according to any of claims 1-3, wherein the step of providing a sequence of characters involves a threshold value to be compared with the measure of matching.

5. The method according to claim 4, wherein the step of providing a sequence of characters includes deciding if the measure of matching is above said threshold value, which threshold value indicates the probability that a segment matches a string.

6. The method according to any of the previous claims, comprising the step of:
arranging the predetermined strings of characters in tables, one table for each segment of characters to be compared.

7. The method according to claim 6, comprising the step of:
creating a pointer that points from a first string of characters in a first table to a second string of characters in a second table, based on the fact that the first string of characters and the second string of characters is most likely to be associated to each other.

8. The method according to claim 7, wherein the use of a pointer enables selection of the best measure of matching among the strings of characters, by comparing the first segment of characters with the strings of characters in the first table.

9. The method according to any of the preceding claims, comprising the step of:
presenting the output sequence of characters to a user.

10. The method according to claim 9, wherein the presenting of the output sequence of characters to a user is made on the display of a device which enables editing of the sequence of characters.

11. The method according to claim 10, wherein the device which enables editing of the sequence of characters is a mobile phone.

12. The method according to any of claims 9-11, comprising the step of:
giving the user an opportunity to accept, or correct, the output sequence of characters, thereby creating a final sequence of characters.

13. The method according to claim 12, comprising the step of:
identifying segments of characters in the final sequence, wherein a segment is added to the corresponding table of strings in case the segment is not already stored in said corresponding table.

14. The method according to claim 13, comprising the step of:
arranging, in the tables, the identified segments of characters comprised in a final sequence of characters with respect to time.

15. The method according to claim 14, wherein the most recently identified segments of characters is provided as an output sequence of characters, if two or more predetermined strings of characters have the same measure of matching when each of the strings is compared to a segment of characters.

16. The method according to any of the preceding claims, wherein the identification of segments of characters in a sequence of characters is performed by identifying at least one segment delimiter.

17. The method according to claim 16, wherein said at least one segment delimiter consists of the character “@” or “.”.

18. The method according to any of the preceding claims, wherein said sequence of characters comprises an e-mail address.

19. The method according to claims 1-15, wherein the identification of segments of characters in a sequence of characters is performed by dividing the sequence into segments comprising predetermined numbers of characters.

20. The method according to any of the preceding claims, wherein said steps are performed by a digital pen.

21. A system for improving a character recognition process, which system comprises:
means arranged to receive a sequence of characters;
means arranged to identify at least one segment of characters in the sequence;
means arranged to compare said at least one segment with predetermined strings of characters, whereby a measure of matching is generated for each string, wherein the comparison is performed on a character by character basis between characters of the segment and characters at corresponding positions in the string and wherein said measure of matching is calculated based on a matching probability associated with each of the characters in the predetermined strings; and
means arranged to provide a sequence of characters comprising at least one segment selected from the predetermined strings, based on the measure of matching, thereby creating an output sequence of characters.

22. The system according to claim 21, wherein the comparing means is arranged to calculate the measure of matching by means of combining the number of character by character matches between the segment and the string.

23. The system according to claim 22, wherein the receiving means is arranged to receive, for at least part of the characters in said sequence, at least one alternative character and a corresponding probability value, wherein the comparing means is arranged to calculate the measure of matching based on the probability value of any alternative character that matches a character at a corresponding position in the string.

24. The system according to any of claims 20-23, wherein the providing means is arranged to involve a threshold value to be compared with the measure of matching, when providing a sequence of characters.

25. The system according to claim 24, wherein the providing means is arranged to decide if the measure of matching is above said threshold value, which threshold value indicates the probability that a segment matches a string, when providing a sequence of characters.

26. The system according to any of the claims 21-25, comprising:
means arranged to arrange the predetermined strings of characters in tables, one table for each segment of characters to be compared.

27. The system according to claim 26, comprising:
means arranged to create a pointer that points from a first string of characters in a first table to a second string of characters in a second table, based on the fact that the first string of characters and the second string of characters is most likely to be associated to each other.

28. The system according to claim 27, wherein the means arranged to create a pointer enables selection of the best measure of matching among the strings of characters, by comparing the first segment of characters with the strings of characters in the first table.

29. The system according to any of claims 20-28, comprising:
means arranged to present the output sequence of characters to a user.

30. The system according to claim 29, wherein the presenting means is arranged to output the sequence of characters on the display of a device which enables editing of the sequence of characters.

31. The system according to claim 30, wherein the device which enables editing of the sequence of characters is a mobile phone.

32. The system according to claim 29-31, comprising:
means arranged to give the user an opportunity to accept, or correct, the output sequence of characters, thereby creating a final sequence of characters.

33. The system according to claim 32, comprising:
means arranged to identify segments of characters in the final sequence, wherein a segment is added to the corresponding table of strings in case the segment is not already stored in said corresponding table.

34. The system according to claim 33, comprising:
means arranged to arrange, in the tables, the identified segments of characters comprised in a final sequence of characters with respect to time.

35. The system according to claim 34, wherein the providing means is arranged to provide the most recently identified segments of characters as an output sequence of characters, if two or more predetermined strings of characters have the same measure of matching when each of the strings is compared to a segment of characters.

36. The system according to any of claims 21-35, wherein the identifying means is arranged to identify segments of characters in a sequence of characters by identifying at least one segment delimiter.

37. The system according to claim 36, wherein said at least one segment delimiter consists of the character “@” or “.”.

38. The system according to any of claims 21-37, wherein said sequence of characters comprises an e-mail address.

39. The system according to claims 21-38, wherein the identifying means is arranged to identify segments of characters in a sequence of characters by dividing the sequence into segments comprising predetermined numbers of characters.

40. The system according to any claims 21-39, wherein said means are comprised in a digital pen.

41. A computer readable medium for storing computer executable components for causing a unit to perform the steps as recited in claims 1-20 when the computer-executable components are run on a microprocessor included by the unit.
